(19) United States
(12) Patent Application Publication
(10) Pub. No.: US 2026/0127151 A1
(43) Pub. Date: May 7, 2026

(54) VECTOR DATABASE INDEXING

(71) Applicant: DevRev, Inc., Palo Alto, CA (US)

(72) Inventors: Pratyush Goel, Ghaziabad (IN); Nimar Arora, Union City, CA (US); Ritesh Goru, Bangalore (IN)

(73) Assignee: DevRev, Inc., Palo Alto, CA (US)

(21) Appl. No.: 18/935,323

(22) Filed: Nov. 1, 2024

(51) Int. Cl. G06F 16/22; G06F 16/33

(52) U.S. Cl. CPC G06F 16/2237; G06F 16/3347

(57) ABSTRACT

Techniques for vector database indexing are described. In an example, a plurality of unstructured data is obtained. Vector embeddings are performed on each unstructured data from amongst the plurality of unstructured data to generate a plurality of vectors. Each vector from amongst the plurality of vectors is indicative of attributes of the unstructured data from amongst the plurality of unstructured data. The plurality of unstructured data and the plurality of vectors is stored in the vector database. A vector index corresponding to the plurality of vectors based on a first indexing mechanism is generated where the vector index includes at least one cluster of vectors with similar attributes. An index mapping is performed to store the vector index into a relational database.

### BACKGROUND

A database is a systematic way of storing information so that data can be accessed, analysed, transformed, updated and transferred with efficiency. A database is usually managed by a database management system (DBMS). The data, the DBMS, and applications associated with the DBMS are referred to as a database system.

There are different types of databases, where one such type is a relational database that manages structured or tabular data. These types of databases are referred to as ‘relational databases’ because data items within such databases have pre-determined relationships with one another. Thus, the relational database allows access to data which is related to one another. A relational database stores numbers, strings and other types of scalar data in the form of rows and columns.

Another type of database is a vector database that allows storage and management of unstructured data, such as text, documents, images, audio, and video. The unstructured data is stored in the vector database in the form of vectors, where a vector is a mathematical representation of attributes of unstructured data. The vectors are generated by applying an embedding function to the unstructured data, where the embedding function is based on different algorithms or models, such as feature extraction algorithms, machine learning models, and word embedding techniques.

The vector database allows fast and accurate similarity search and retrieval of unstructured data based on vector distance similarity. Therefore, the vector database is used for effective storage and retrieval of unstructured data while providing similar results based on semantic or contextual meaning.

### BRIEF DESCRIPTION OF DRAWINGS

FIG. 1 illustrates an Index Mapping System (IMS) for implementing a vector database, in accordance with an example of the present subject matter;

FIG. 2 illustrates the IMS for implementing a vector database, in accordance with another example of the present subject matter;

FIGS. 3, 4, and 5 illustrate example tables.

FIG. 6 illustrates a method for implementing a vector database, in accordance with an example of the present subject matter;

FIG. 7 illustrates a non-transitory computer-readable medium for implementing a vector database, in accordance with an example of the present subject matter.

Throughout the drawings, identical reference numbers designate similar, but not necessarily identical elements. The drawings provide examples and/or implementations consistent with the description; however, the description is not limited to the examples and/or implementations provided in the drawings.

### DETAILED DESCRIPTION

In vector databases, a combination of different algorithms is used that allows Approximate Nearest Neighbour (ANN) search. Such algorithms optimize the search through hashing, quantization, or graph-based search. Vector databases can be used to find the most similar data based on the semantic or contextual meaning of the data, instead of using conventional methods of querying databases based on exact matches or predefined criteria.

To ensure effective storage and search of the unstructured data, the unstructured data stored in a vector database is indexed. The indexing of the vector database includes performing vector embedding on unstructured data to generate vectors corresponding to the unstructured data, clustering the vectors based on the attributes of the vectors, and storing the vectors in the vector index. The mechanics of indexing the vectors has a direct bearing on the efficiency and latency experienced by the database in managing a data retrieval query, such as a nearest neighbour search.

Generally, for a nearest neighbour query, the vector database is pre-processed to create an index for querying. For a given query vector, the index is used to identify a set of vectors that are likely to be close to the query vector. When a vector database receives a query, the vector database compares the indexed vectors to the query vector to determine the nearest vector neighbour. To establish nearest neighbour, the vector database may rely on mathematical methods, such as similarity measures. Similarity measures include Cosine similarity to establish similarity by measuring the cosine of the angle between two vectors in a vector space, Euclidean distance to establish similarity by measuring the straight-line distance between vectors, and Dot product to establish similarity by measuring the product of the magnitude of two vectors and the cosine of the angle between them. The nearest neighbour vectors are then retrieved from the indexed vector database and returned to a user as the search results.

Conventional approaches for implementation of the vector database store the index in fast access memories, such as Random Access Memory (RAM) or Cache memory, to provide a quick response to a nearest neighbour query. However, such approaches do not scale well in multi-tenant environments. The non-scalability of the conventional approaches in the multi-tenant environments may be attributed to the involvement of a significant amount of storage costs required for handling large unstructured datasets corresponding to a plurality of tenants.

For instance, one of the known vector database implementation techniques allows developers to build Approximate nearest neighbour indexes and perform k-nearest neighbours (KNN) query. The technique uses object storage to reduce the storage cost and provides an interface for developers to define their own index which can then be queried by the users. The indexes are kept in memory to perform fast approximate nearest neighbour search. Further, in order to enable multi-tenancy, a separate index needs to be built for each tenant and to serve all the tenants a sub 100 ms response, the indexes need to be kept in memory which increases the memory requirement and the cost of the system significantly. However, retrieval from object storage is a bit slower compared to Solid-State Disk (SSD) backed databases. The indexes backed by object storage are not real time in nature and require re-indexing periodically which adds significant computational time.

Another known technique uses the Hierarchical Navigable Small World (HNSW) algorithm for vector similarity search which supports a live index with immediate Create, Read, Update, and Delete (CRUD) operations. The technique uses memory-mapped files for data stored on disks, which helps make disk lookups more efficient. In addition, the technique holds portions of the HNSW index in memory. For example, for optimal search and import performance all previously imported vectors are held in memory. The technique is optimized to work with Solid-State Disks (SSDs). However, spinning hard-disks can be used with some performance penalties. Constant memory usage for an index not being used and usage of Solid-State disks increase the total cost of the system. The memory requirements are significant for HNSW which does not scale well for multiple tenants.

According to examples of the present subject matter, techniques for vector database indexing are described.

In an example, a plurality of unstructured data may be obtained. Vector embedding on each unstructured data from amongst the plurality of unstructured data may then be performed. The vector embedding may be performed to generate a plurality of vectors, where each vector from amongst the plurality of vectors is indicative of attributes of the unstructured data from amongst the plurality of unstructured data. The plurality of unstructured data and the plurality of vectors may then be stored in the vector database. A vector index corresponding to the plurality of vectors may then be generated, where the vector index comprises of clusters of vectors with similar attributes. The vector index may be generated based on a first indexing mechanism. In an example, the first indexing mechanism is Hierarchical Navigable Small World (HNSW) indexing mechanism. The index mapping may then be performed to store the vector index into a relational database.

By allowing storage of the vector index in the relational database based on the index mapping, the present approach uses cost effective storage and allows the system to store embeddings in the form of vectors and creates indexes for each tenant which can then be queried to compute the nearest neighbour vectors to any input vector. Further, as the indexing is performed based on existing vector indexing techniques, such as the HNSW indexing mechanism, the present subject matter permits enhanced application of an approximate nearest neighbour vector search, such as similarity search, semantic search, ticket de-duplication and deflections, while providing the advantages related to the storage cost. Further, the vector database also supports a live index that allows synchronous Create/Update/Delete operations to the vector entities.

Unlike conventional vector database solutions which do not scale in a multi-tenant environment and requires significant amount of memory associated with high costs, the present subject matter is a complete on-disk solution, thereby ensuring that the indexes can be scaled to millions of tenants while keeping the memory costs minimal. Accordingly, the present subject matter provides an improved and efficient approach to implement a vector database.

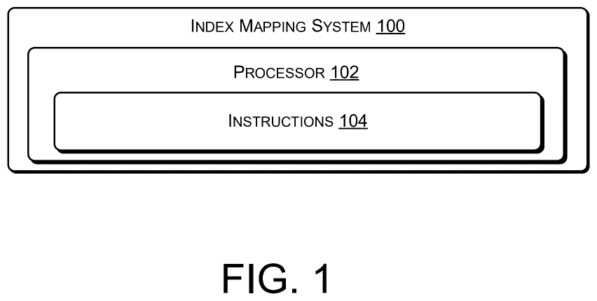

The manner in which the example vector database is implemented is explained in detail with respect to FIG. 1 to FIG. 7. While aspects of the described computing device may be implemented in any number of different electronic devices, environments, and/or implementations, the examples are described in the context of the following example device(s). It is to be noted that drawings of the present subject matter shown here are for illustrative purposes and are not to be construed as limiting the scope of the subject matter claimed.

FIG. 1 illustrates an Index Mapping System (IMS) 100 for implementing a vector database, in accordance with an example of the present subject matter. The IMS 100 may include a processor 102. The processor 102 may fetch and execute the computer-readable instructions 104 stored in a memory (not depicted in FIG. 1), to facilitate implementation of the vector database.

In an example implementation, the processor 102 may cause the IMS 100 to obtain a plurality of unstructured data. The processor 102 may then cause the IMS (100) to perform vector embeddings on each unstructured data from amongst the plurality of unstructured data to generate plurality of vectors. In an example, each vector from amongst the plurality of vectors may be indicative of attributes of the unstructured data from amongst the plurality of unstructured data. The processor 102 may then cause the IMS to store the plurality of unstructured data and the plurality of vectors in the vector database.

The processor 102 may then cause the IMS to generate a vector index corresponding to the plurality of vectors based on a first indexing mechanism, where the vector index comprises of at least one cluster of vectors with similar attributes. In an example, the first indexing mechanism is Hierarchical Navigable Small World (HNSW) indexing mechanism. The processor 102 may then cause the IMS 100 to perform an index mapping to store the vector index into a relational database.

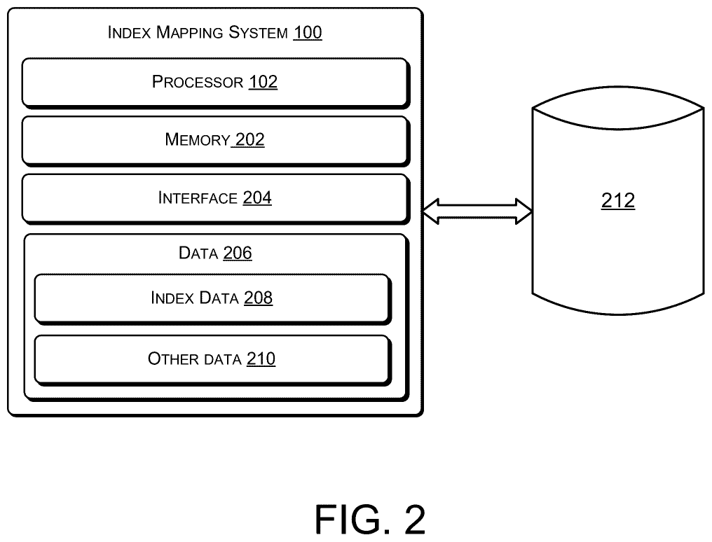

FIG. 2 illustrates the IMS for implementing a vector database, in accordance with an example of the present subject matter.

The IMS 100 may include the processor 102, a memory 202 coupled to the processor 102, and an interface 204 coupled to the memory 202. The functions of various elements shown in the figures, including any functional blocks labelled as “processor(s)”, may be provided through the use of dedicated hardware as well as hardware capable of executing instructions. When provided by a processor, the functions may be provided by a single dedicated processor, by a single shared processor, or by a plurality of individual processors, some of which may be shared. Moreover, explicit use of the term “processor” would not be construed to refer exclusively to hardware capable of executing instructions, and may implicitly include, without limitation, digital signal processor (DSP) hardware, network processor, application specific integrated circuit (ASIC), field programmable gate array (FPGA). Other hardware, standard and/or custom, may also be coupled to the processor 102.

The memory 202 may be a computer-readable medium, examples of which include volatile memory (e.g., RAM), and/or non-volatile memory (e.g., Erasable Programmable read-only memory, i.e., EPROM, flash memory, etc.). The memory 202 may be an external memory, or internal memory, such as a flash drive, a compact disk drive, an external hard disk drive, or the like. The memory 202 may further include data which either may be utilized or generated during the operation of the IMS 100.

The interface 204 may allow the connection or coupling of the IMS 100 with one or more other devices, through a wired (e.g., Local Area Network, i.e., LAN) connection or through a wireless connection (e.g., Bluetooth®, WiFi). The interface 204 may also enable intercommunication between different logical as well as hardware components of the IMS 100.

The IMS 100 may further include data 206 that may be utilized or generated by the processor 102 while performing a variety of functions. In an example, the data 206 includes index data 208, and other data 210. The other data 210, amongst other things, may serve as a repository for storing data that is processed, or received, or generated as a result of the execution of the instructions by the processor 102.

In an example, the IMS 100 may be communicatively coupled to a vector database, such as vector database 212. The IMS 100 may be coupled to the vector database 212 either through a direct communication link, or through multiple communication links of a communication network (not shown). The communication network may be a wireless or a wired network, or a combination thereof. The communication network can be a collection of individual networks, interconnected with each other and functioning as a single large network. Examples of such individual networks include, but are not limited to, Global System for Mobile communication (GSM) network, Universal Mobile Telecommunications System (UMTS) network, Long Term Evolution (LTE) network, personal communications service (PCS) network, Time-division multiple access (TDMA) network, Code-Division Multiple Access (CDMA) network, next-generation network (NGN), public switched telephone network (PSTN), and Integrated Services Digital Network (ISDN). Depending on the terminology, the communication network includes various network entities, such as gateways and routers; however, such details have been omitted to maintain the brevity of the description.

In an example implementation, the processor 102 may cause the IMS 100 to obtain a plurality of unstructured data. Examples of the unstructured data may include images, text documents, audio files, social media posts, video files, and emails.

The processor 102 may then cause the IMS 100 to perform vector embeddings on each unstructured data from amongst the plurality of unstructured data to generate a plurality of vectors. Each vector from amongst the plurality of vectors may be numerical representations that are indicative of attributes of unstructured data. The processor may then cause the plurality of unstructured data and the plurality of vectors to be stored in the vector database 212.

In an example, the processor 102 may perform vector embedding by transforming the plurality of unstructured data into vectors using an embedding model. In the example, the embedding model may be trained using a deep convolutional neural network. To train the embedding model, a large set of unstructured data, such as text or images, may be assembled. Further, depending on a type of unstructured data, the unstructured data may be pre-processed for eliminating noise, resizing photos, normalizing text, and carrying out additional operations. The embedding model may then be trained using the pre-processed data set to identify links and patterns in the data. After training, the embedding model may transform new unstructured data into vectors representing a meaningful and structured representation that effectively encapsulates the semantic information of the original unstructured data.

The processor 102 may then cause the IMS 100 to generate a vector index corresponding to the plurality of vectors based on a first indexing mechanism, where the vector index includes at least one cluster of vectors with similar attributes. In an example, the first indexing mechanism may be Hierarchical Navigable Small World (HNSW) indexing mechanism. HNSW is an indexing mechanism for approximate nearest neighbour vector search that builds a multi-layer graph structure. HNSW is an approach for approximate nearest neighbour vector search that builds a multi-layer graph structure. HNSW works by constructing a multi-layered graph for all the vectors in the space.

The processor 102 may then cause the IMS 100 to perform an index mapping to store the vector index corresponding to the plurality of vectors into a relational database. In an example, to perform index mapping, the processor 102 may cause the IMS 100 to create of multiple interrelated table structures in the relational database, where the different interrelated table structures may store different parts of the vector index.

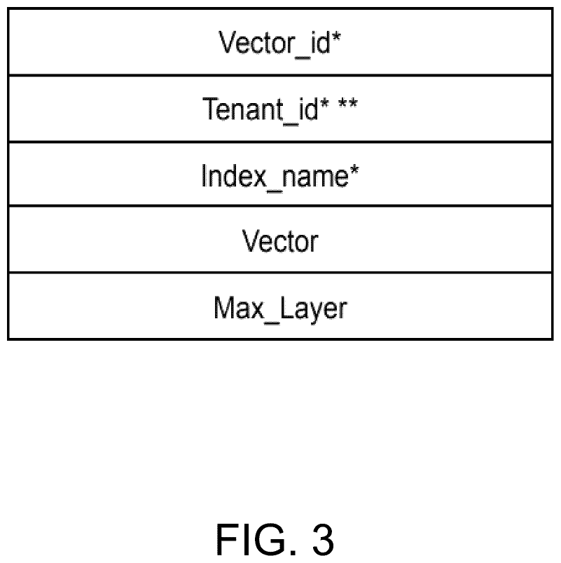

For instance, the processor 102 may cause the IMS 100 to create a first table structure that includes the plurality of vectors and the metadata corresponding to the plurality of vectors. In the example, the metadata of the first table structure corresponding to each of the plurality of vectors comprises a vector ID, a tenant ID, an index name, and an identifier of a maximum layer at which each of the plurality of vectors is found. An exemplary first table structure is illustrated in FIG. 3.

As a part of index mapping, the processor 102 may further cause the IMS 100 to further create a second table structure comprising metadata corresponding to a first vector from the plurality of vectors and a list of neighbour vectors corresponding to the first vector. The metadata of the second table structure corresponding to the first vector comprises a vector ID, a tenant ID, an index name, and an identifier of a layer comprising the first vector. In an example, the second table structure may be linked to the first table structure by at least one of the vector ID and the tenant ID corresponding to the first vector.

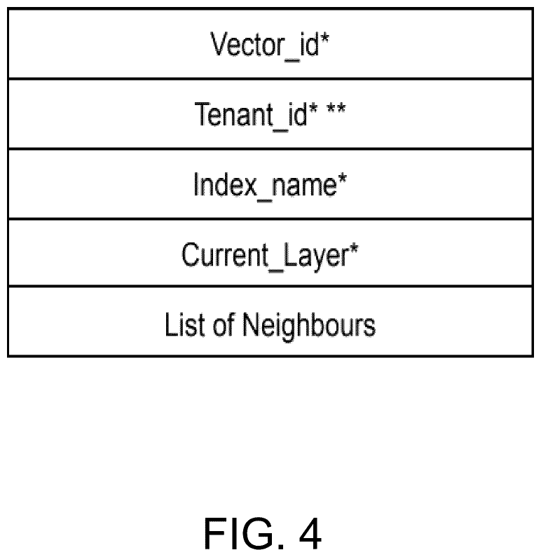

An exemplary second table structure is illustrated in FIG. 4.

As part of index mapping, the processor 102 may further cause the IMS 100 to create a third table structure comprising an entry point for a query vector corresponding to the first vector and metadata corresponding to the first vector. The metadata of the third table structure corresponding to the first vector comprises the tenant ID, the index name, and default and construction parameters corresponding to the first vector. The third table structure may be related to the second table structure by at least the tenant ID of the first vector.

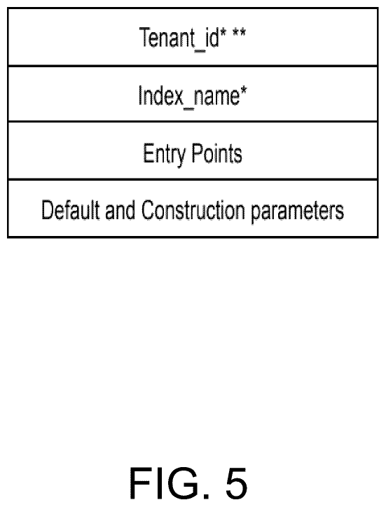

An exemplary third table structure is illustrated in FIG. 5.

In an example, the processor 102 may cause the IMS 100 to shard the vector index stored in the relational database. In an example, the processor 102 may shard the vector index for a plurality of tenants in a multi-tenant environment. In the example, the processor 102 may cause the IMS 100 to shard the vector index based on at least one of the index name and the tenant ID corresponding to the plurality of tenants.

The processor 102 may cause the IMS 100 to perform CRUD operations on the vector index. In an example, the processor 102 may cause the IMS 100 to allow accessing at least one unstructured data from the plurality of unstructured data. The at least one unstructured data from the plurality of unstructured data may be accessed upon receiving a query vector. The vector index stored on the relational database may be searched using the query vector to identify a nearest neighbour vector corresponding to the query vector. The nearest neighbour vector may then be utilized to identify and access unstructured data from the vector database.

To identify the nearest neighbour vectors corresponding to the query vector, the processor 102 may cause the IMS 100 to retrieve the at least one entry point for the vector index. The processor 102 may then cause the IMS 100 to utilize the at least one entry point for searching the top layer to identify a nearest neighbour vector corresponding to the query vector in the top layer. The processor 102 may then cause the IMS 100 to update the first nearest neighbour vector as an entry point to a second layer next to the top layer. Thereafter, for each layer starting from the layer next to the top layer to a last layer in the vector index, a current layer may be searched with the query vector to identify the nearest neighbour vector corresponding to the query vector in the current layer and the nearest neighbour vector may be updated as an entry point to a layer subsequent to the current layer. The processor 102 may then cause the IMS 100 to find the nearest neighbour vector corresponding to the query vector. The processor 102 may then cause the IMS 100 to return the nearest neighbour vector corresponding to the query vector.

In another example, the processor 102 may cause the IMS 100 to further insert a new vector in the vector database. To insert the new vector, the processor 102 may cause the IMS 100 to retrieve the at least one entry point from the third table structure. Thereafter, the processor 102 may cause the IMS 100 to assign a new maximum layer to the new vector. To assign a new maximum layer, the processor 102 may cause the IMS to determine the new maximum layer using a probabilistic method which follows an exponential distribution. The processor 102 may cause the IMS 100 to use the following formula for computing the new maximum layer for a new node;

L=[−log(random)×λ]

where
random is a uniformly distributed random variable between 0 and 1,
λ is a hyperparameter that controls the probability distribution of the levels (usually λ=log(M)1, and
M is the maximum number of connections per node).
   The processor 102 then causes the IMS 100 to round down the result to the nearest integer, ensuring that higher levels have exponentially fewer nodes. If the new maximum layer is greater than the top layer, then the processor 102 may cause the IMS 100 to set the new maximum layer to one level higher than top layer. The processor 102 may then cause the IMS 100 to update the entry point to be the new vector and the top layer count may be incremented by one.

The processor 102 may then cause the IMS 100 to update an entry point corresponding to each layer, by searching each layer with the new vector based on the at least one entry point for each layer from the top layer to the new maximum layer. Subsequently, from the new maximum layer to a last layer of the vector index, the processor 102 may cause the IMS 100 to search each layer with the new vector and the entry point corresponding to each layer to identify a plurality of nearest neighbour vectors corresponding to the new vector. The processor 102 may then cause the IMS 100 to identify a predetermined number of nearest neighbour vectors from amongst the plurality of nearest neighbour vectors corresponding to the new vector. Thereafter, the processor 102 may cause the IMS 100 to create an edge between new vector and each vector from amongst the predetermined number of nearest vectors. The processor 102 may then cause the IMS 100 to set the entry points to newly identified vectors.

In an example, the processor 102 may cause the IMS 100 to determine that a list of neighbour vectors comprising the plurality of nearest neighbour vectors exceeds a maximum length (M). In such a situation the processor may cause IMS 100 to delete at least one existing edge.

In yet another example, the processor 102 may cause the IMS 100 to delete an existing vector from the vector database. In operation, to delete the existing vector, the processor 102 may cause the IMS 100 to identify a plurality of neighbour vectors corresponding to the existing vector on each layer from the top layer to a last layer of the vector index. The processor 102 may then cause the IMS 100 to update a list of neighbour vectors for each neighbour vector from amongst the plurality of neighbour vectors on each layer, from the top layer to the last layer, to remove reference to the existing vector.

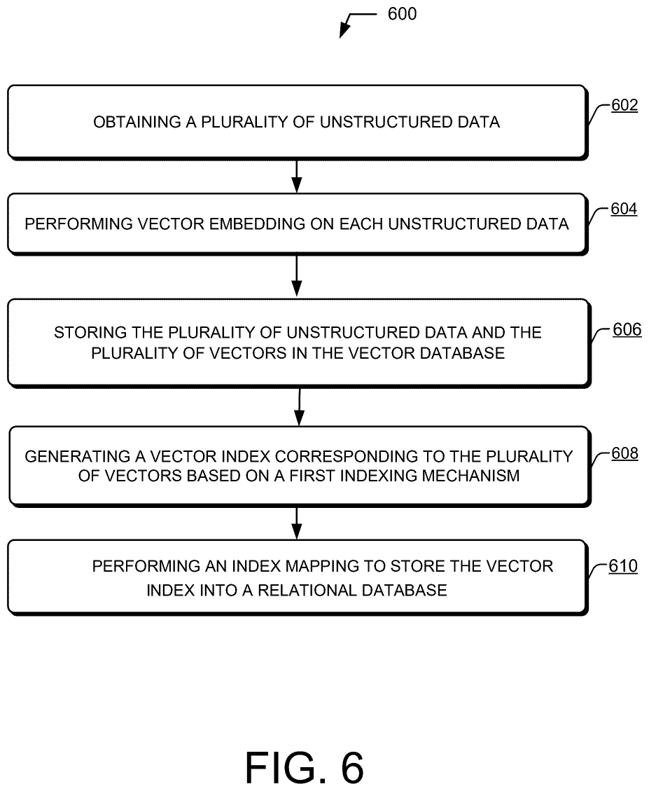

FIG. 6 illustrates a method 600 for implementing a vector database, in accordance with an example of the present subject matter. The order in which the method 600 is described is not intended to be construed as a limitation, and any number of the described method blocks may be combined in any order to implement the method 600, or an alternative method. Furthermore, the method 600 may be implemented by processor(s) or computing device(s) through any suitable hardware, non-transitory machine-readable instructions, or a combination thereof.

It may be understood that steps of the method 600 may be performed by programmed computing devices and may be executed based on instructions stored in a non-transitory computer readable medium. The non-transitory computer readable medium may include, for example, digital memories, magnetic storage media, such as magnetic disks and magnetic tapes, hard drives, or optically readable digital data storage media. In an example, the method 600 may be performed by the IMS 100.

At step 602, a plurality of unstructured data is obtained. The unstructured data may be unorganised data that do not conform to a data model. Examples of the unstructured data may include images, text documents, audio files, social media posts, video files, and emails.

At step 604, vector embedding on each unstructured data is performed from amongst the plurality of unstructured data to generate a plurality of vectors. In an example, each vector from amongst the plurality of vectors is indicative of attributes of unstructured data. In an example, each vector from amongst the plurality of vectors may be numerical representations that are indicative of attributes of unstructured data. The vector embedding may be performed by transforming the plurality of unstructured data by an embedding model.

At step 606, the plurality of unstructured data and the plurality of vectors is stored in the vector database.

At step 608, a vector index corresponding to the plurality of vectors based is generated. The vector index may be a cluster of vectors with similar attributes. In an example, the vector index may be generated based on a first indexing mechanism, where the first indexing mechanism is HSNW indexing mechanism.

At step 610, an index mapping is performed to store the vector index corresponding to the plurality of vectors into a relational database. In an example, to perform index mapping, multiple interrelated table structures may be created in the relational database, where the different interrelated table structures may store different parts of the vector index. For instance, performing the index mapping may include creation of a first table structure that includes the plurality of vectors and the metadata corresponding to the plurality of vectors. In the example, the metadata of the first table structure corresponding to each of the plurality of vectors comprises a vector ID, a tenant ID, an index name, and an identifier of a maximum layer at which each of the plurality of vectors is found.

Performing the index mapping may further include creation of a second table structure comprising metadata corresponding to a first vector from the plurality of vectors and a list of neighbour vectors corresponding to the first vector. The metadata of the second table structure corresponding to the first vector comprises a vector ID, a tenant ID, an index name, and an identifier of a layer comprising the first vector. In an example, the second table structure may be linked to the first table structure by at least one of the vector ID and the tenant ID corresponding to the first vector.

Performing the index mapping may further include creation of a third table structure comprising an entry point for a query vector corresponding to the first vector and metadata corresponding to the first vector. The metadata of the third table structure corresponding to the first vector comprises the tenant ID, the index name, and default and construction parameters corresponding to the first vector. The third table structure may be related to the second table structure by at least the tenant ID of the first vector.

In an example, the method may further include performing CRUD operations of the vector index. In an example, the method may include accessing at least one unstructured data from the plurality of unstructured data. The at least one unstructured data from the plurality of unstructured data may be accessed upon receiving a query vector. In operation, the vector index stored on the relational database may be searched using the query vector to identify a nearest neighbour vector corresponding to the query vector and the unstructured data may be identified using the nearest neighbour vector.

To identify the nearest neighbour vectors corresponding to the query vector, the at least one entry point may be retrieved for the vector index. The at least one entry point may be then utilized for searching the top layer to identify a nearest neighbour vector corresponding to the query vector in the top layer. The first nearest neighbour vector may then be updated as an entry point to a second layer next to the top layer. Thereafter, for each layer starting from the layer next to the top layer to a last layer in the vector index, a current layer may be searched with the query vector to identify the nearest neighbour vector corresponding to the query vector in the current layer and the nearest neighbour vector may be updated as an entry point to a layer subsequent to the current layer. The nearest neighbour vector corresponding to the query vector may then be found. The nearest neighbour vector corresponding to the query vector may then be returned.

In another example, the method may further include inserting a new vector in the vector database. To insert the new vector, the at least one entry point may be retrieved from the third table structure. Thereafter, a new maximum layer may be assigned to the new vector. If the new maximum layer is greater than the top layer, the new maximum layer may be set to one level higher than top layer. The entry point may be updated to be the new vector and the top layer count may be incremented by one.

An entry point corresponding to each layer may then be updated by searching each layer with the new vector based on the at least one entry point for each layer from the top layer to the new maximum layer. Subsequently, from the new maximum layer to a last layer of the vector index, each layer may be searched with the new vector and the entry point corresponding to each layer to identify a plurality of nearest neighbour vectors corresponding to the new vector. A predetermined number of nearest neighbour vectors from amongst the plurality of nearest neighbour vectors may then be identified corresponding to the new vector. Thereafter, an edge may be created between the new vector and each vector from amongst the predetermined number of nearest vectors. The entry points may then be set to newly identified vectors. In an example, a list of neighbour vectors comprising the plurality of nearest neighbour vectors may be determined to exceed a maximum length (M). In such a situation, at least one existing edge may be deleted.

In yet another example, the method may include deleting an existing vector from the vector database. In operation, to delete the existing vector, a plurality of neighbour vectors corresponding to the existing vector on each layer, from the top layer to a last layer of the vector index, may be identified. A list of neighbour vectors may then be updated for each neighbour vector from amongst the plurality of neighbour vectors on each layer, from the top layer to the last layer, to remove reference to the existing vector.

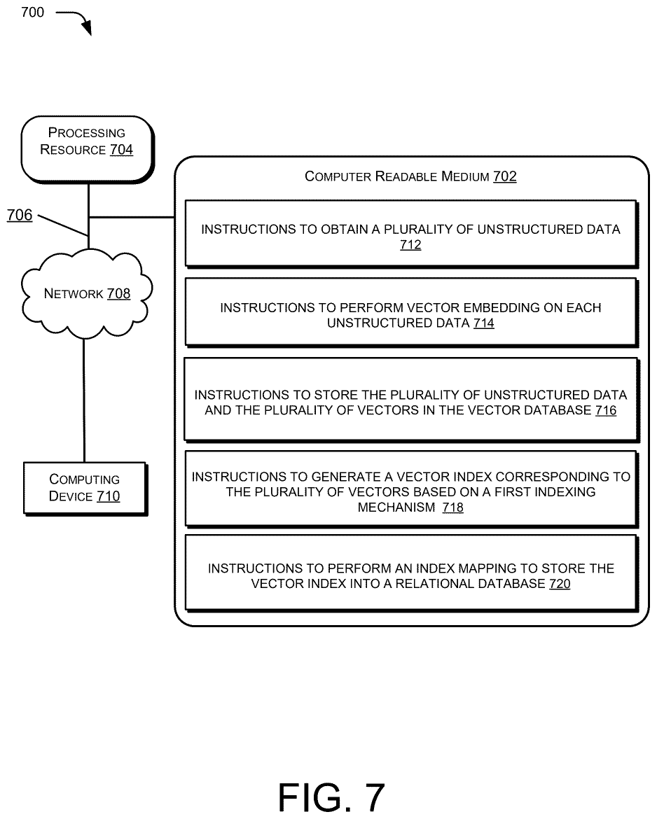

FIG. 7 illustrates a computing environment 700, implementing a non-transitory computer-readable medium for implementing a vector database, according to an example implementation of the present subject matter.

In an example, the non-transitory computer-readable medium 702 may be utilized by the computing device 710. The computing device 410 may correspond to the IMS 100. The computing device 710 may be implemented in a public networking environment or a private networking environment. In an example, the computing environment 700 may include a processing resource 704 communicatively coupled to the non-transitory computer-readable medium 702 through a communication link 706.

In an example, the processing resource 704 may be implemented in a device, such as the computing device 710. The non-transitory computer-readable medium 702 may be, for example, an internal memory device of the computing device 710 or an external memory device. In an implementation, the communication link 706 may be a direct communication link, such as any memory read/write interface. In another implementation, the communication link 706 may be an indirect communication link, such as a network interface. In such a case, the processing resource 704 may access the non-transitory computer-readable medium 702 through a network 708. The network 708 may be a single network or a combination of multiple networks and may use a variety of different communication protocols. The processing resource 704 and the non-transitory computer-readable medium 702 may also be communicatively coupled to the computing device 710 over the network 708.

In an example implementation, the non-transitory computer-readable medium 702 includes a set of computer-readable instructions to implement a vector database. The set of computer-readable instructions can be accessed by the processing resource 704 through the communication link 706 and subsequently executed to perform acts to provide feedback to the actuating object.

Referring to FIG. 4, in an example, the non-transitory computer-readable medium 702 includes instructions 712 to obtain a plurality of unstructured data. The unstructured data may be unorganised data that do not conform to a data model. Examples of the unstructured data may include images, text documents, audio files, social media posts, video files, and emails.

The non-transitory computer-readable medium 702 further includes instructions 714 to perform vector embedding on each unstructured data from amongst the plurality of unstructured data to generate plurality of vectors, where each vector from amongst the plurality of vectors is indicative of attributes of unstructured data. In an example, each vector from amongst the plurality of vectors may be numerical representations that are indicative of attributes of unstructured data. The vector embedding may be performed by transforming the plurality of unstructured data by an embedding model.

The non-transitory computer-readable medium 702 further includes instructions 716 to store the plurality of unstructured data and the plurality of vectors in the vector database.

The non-transitory computer-readable medium 702 includes instructions 718 to generate a vector index corresponding to the plurality of vectors based on a first indexing mechanism, where the vector index is a cluster of vectors having similar attributes. In an example, the first indexing mechanism may be HNSW indexing mechanism.

The non-transitory computer-readable medium 702 includes instructions 720 to perform an index mapping to store the vector index into a relational database. In an example, to perform index mapping, the instructions 720 may create multiple interrelated table structures in the relational database, where the different interrelated table structures may store different parts of the vector index. For instance, to perform index mapping, the instructions 720 may create a first table structure that includes the plurality of vectors and the metadata corresponding to the plurality of vectors. The metadata of the first table structure corresponding to each of the plurality of vectors comprises a vector ID, a tenant ID, an index name, and an identifier of a maximum layer at which each of the plurality of vectors is found.

To perform the index mapping, the instructions 720 may further create a second table structure comprising metadata corresponding to a first vector from the plurality of vectors and a list of neighbour vectors corresponding to the first vector. The metadata of the second table structure corresponding to the first vector comprises a vector ID, a tenant ID, an index name, and an identifier of a layer comprising the first vector. In an example, the second table structure may be linked to the first table structure by at least one of the vector ID and the tenant ID corresponding to the first vector.

To perform the index mapping, the instructions 720 may further create a third table structure comprising an entry point for a query vector corresponding to the first vector and metadata corresponding to the first vector. The metadata of the third table structure corresponding to the first vector comprises the tenant ID, the index name, and default and construction parameters corresponding to the first vector. The third table structure may be related to the second table structure by at least the tenant ID of the first vector.

In an example, the instructions 720 may further perform CRUD instructions on the vector index. In an example, the instructions 720 may access at least one unstructured data from the plurality of unstructured data. The at least one unstructured data from the plurality of unstructured data may be accessed upon receiving a query vector. The instructions 720 may search the vector index stored on the relational database using the query vector to identify a nearest neighbour vector corresponding to the query vector. Once the nearest neighbour vector is identified, the instructions 720 may cause the unstructured data to be identified using the nearest neighbour vector.

To identify the nearest neighbour vectors corresponding to the query vector, the instructions 720 may retrieve the at least one entry point for the vector index. The instructions 720 may utilize the at least one entry point for searching the top layer to identify a nearest neighbour vector corresponding to the query vector in the top layer. The instructions 720 may update the first nearest neighbour vector as an entry point to a second layer next to the top layer. Thereafter, for each layer starting from the layer next to the top layer to a last layer in the vector index, the instructions 720 may search a current layer with the query vector to identify the nearest neighbour vector corresponding to the query vector in the current layer and the nearest neighbour vector may be updated as an entry point to a layer subsequent to the current layer. The instructions 720 may then find the nearest neighbour vector corresponding to the query vector. The instructions 720 may return the nearest neighbour vectors corresponding to the query vector.

In another example, the instructions 720 may insert a new vector in the vector database. To insert the new vector, the instructions 720 may retrieve the at least one entry point from the third table structure. Thereafter, the instructions 720 may assign a new maximum layer to the new vector. If the new maximum layer is greater than the top layer, the instructions 720 may set the new maximum layer to one level higher than top layer. The instructions 720 may then update the entry point to be the new vector and the top layer count may be incremented by one.

The instructions 720 may then search an entry point corresponding to each layer by searching each layer with the query vector based on the at least one entry point for each layer from the top layer to the new maximum layer. Subsequently, from the new maximum layer to a last layer of the vector index, the instructions 720 may search each layer with the query vector and the entry point corresponding to each layer to identify a plurality of nearest neighbour vectors corresponding to the query vector. The instructions 720 may then identify a predetermined number of nearest neighbour vectors from amongst the plurality of nearest neighbour vectors corresponding to the query vector. Thereafter, the instructions 720 may create an edge between the new vector and each vector from amongst the predetermined number of nearest vectors. The instructions 720 may then set the entry points to newly identified vectors. In an example, the instructions 720 may determine that a list of neighbour vectors comprising the plurality of nearest neighbour vectors exceeds a maximum length (M). In such a situation, the instructions 720 may delete at least one existing edge.

In yet another example, the instructions 720 may delete an existing vector from the vector database. In operation, to delete the existing vector, the instructions 720 may identify a plurality of neighbour vectors corresponding to the existing vector on each layer, from the top layer to a last layer of the vector index. The instructions 720 may update a list of neighbour vectors for each neighbour vector from amongst the plurality of neighbour vectors on each layer, from the top layer to the last layer, to remove reference to the existing vector.

The present subject matter is directed to an improved approach to implement a vector database. The present approach uses cost effective storage and allows the system to store embeddings in the form of vectors and creates indexes for each tenant which can then be queried to compute the nearest neighbour vectors to any input vector. Further, as the indexing is performed based on existing vector indexing techniques, such as the HNSW indexing mechanism, the present invention permits enhanced application of an approximate nearest neighbour vector search such as similarity search, semantic search, ticket de-duplication and deflections, while providing the advantages related to the storage cost. Further, the vector database also supports a live index that allows synchronous Create/Update/Delete operations to the vector entities.

Further, the vector database provides fast and efficient billion scale approximate nearest neighbour vector search for multiple tenants. Unlike conventional vector database solutions which do not scale in a multi-tenant environment and requires significant amount of memory associated with high costs, the present subject matter is a complete on-disk solution, thereby ensuring that the indexes can be scaled to millions of tenants while keeping the memory costs minimal. Accordingly, the present subject matter provides an improved and efficient approach to implement a vector database.

Although examples and implementations of present subject matter have been described in language specific to structural features and/or methods, it is to be understood that the present subject matter is not necessarily limited to the specific features or methods described. Rather, the specific features and methods are disclosed and explained in the context of a few example implementations of the present subject matter.

1. A method for implementation of a vector database, the method comprising:
obtaining a plurality of unstructured data;
performing vector embedding on each unstructured data from amongst the plurality of unstructured data to generate a plurality of vectors, wherein each vector from amongst the plurality of vectors is indicative of attributes of the unstructured data from amongst the plurality of unstructured data;
storing the plurality of unstructured data and the plurality of vectors in the vector database;
generating a vector index corresponding to the plurality of vectors based on a first indexing mechanism, wherein the vector index comprises at least one cluster of vectors with similar attributes; and
performing an index mapping to store the vector index into a relational database.

2. The method of claim 1, wherein performing the index mapping comprises creating a first table structure comprising the plurality of vectors and metadata corresponding to the plurality of vectors, and the metadata corresponding to each of the plurality of vectors comprises at least one of a vector ID, a tenant ID, an index name, and an identifier of a maximum layer at which each of the plurality of vectors is found.

3. The method of claim 2, wherein performing the index mapping comprises creating a second table structure comprising metadata corresponding to a first vector from amongst the plurality of vectors and a list of neighbour vectors corresponding to the first vector, and the metadata corresponding to the first vector comprises at least one of a first vector ID, a first tenant ID, a first index name, and a first identifier of a layer comprising the first vector.

4. The method of claim 3, wherein performing the index mapping comprises creating a third table structure comprising at least one entry point to the vector index and metadata corresponding to the first vector, wherein the entry point corresponds to a top layer of the vector index and the metadata corresponding to the first vector comprises at least one of the first tenant ID, the first index name, and default and construction parameters corresponding to the first vector.

5. The method of claim 1, the method further comprises sharding of the relational database for a plurality of tenants.

6. The method of claim 4, wherein the method further comprises accessing at least one unstructured data from the plurality of unstructured data, wherein the accessing comprises:
receiving a query vector;
searching the vector index stored on the relational database using the query vector to identify a nearest neighbour vector corresponding to the query vector; and
identifying the unstructured data using the nearest neighbour vector.

7. The method of claim 6, wherein identifying the nearest neighbour vector corresponding to the query vector comprises:
retrieving the at least one entry point for the vector index;
utilizing the at least one entry point for searching the top layer to identify a nearest neighbour vector corresponding to the query vector in the top layer;
updating the nearest neighbour vector as an entry point to a second layer next to the top layer;
for each layer starting from the layer next to the top layer to a last layer in the vector index:
searching a current layer with the query vector to identify the nearest neighbour vector corresponding to the query vector in the current layer;
updating the nearest neighbour vector as an entry point to a layer subsequent to the current layer; and
finding nearest neighbour vectors to the query vector; and
returning the nearest neighbour vectors to the query vector.

8. An Index Mapping System (IMS) for a vector database, the IMS comprising:
at least one processor and at least one memory storing instructions that, when executed by the at least one processor, cause the IMS at least to:
obtain a plurality of unstructured data;
perform vector embedding on each unstructured data from amongst the plurality of unstructured data to generate a plurality of vectors, wherein each vector from amongst the plurality of vectors is indicative of attributes of the unstructured data from amongst the plurality of unstructured data;
store the plurality of unstructured data and the plurality of vectors in the vector database;
generate a vector index corresponding to the plurality of vectors based on a first indexing mechanism, wherein the vector index comprises at least one cluster of vectors with similar attributes; and
perform an index mapping to store the vector index into a relational database.

9. The IMS of claim 8, wherein to perform the index mapping, the at least one processor causes the IMS to create a first table structure comprising the plurality of vectors and metadata corresponding to the plurality of vectors, wherein the metadata corresponding to each of the plurality of vectors comprises at least one of a vector ID, a tenant ID, an index name, and an identifier of a maximum layer at which each of the plurality of vectors is found.

10. The IMS of claim 9, wherein to perform the index mapping, the at least one processor causes the IMS to create a second table structure comprising metadata corresponding to a first vector from amongst the plurality of vectors and a list of neighbour vectors corresponding to the first vector, and the metadata corresponding to the first vector comprises at least one of a first vector ID, a first tenant ID, a first index name, and a first identifier of a layer comprising the first vector.

11. The IMS of claim 10, wherein to perform the index mapping, the at least one processor causes the IMS to create a third table structure comprising at least one entry point to the vector index, the entry point corresponding to a top layer of the vector index, and the metadata corresponding to the first vector comprises at least one of the first tenant ID, the first index name, and default and construction parameters corresponding to the first vector.

12. The IMS as claimed in claim 8, wherein the first indexing mechanism is Hierarchical Navigable Small World (HNSW) indexing mechanism.

13. The IMS as claimed in claim 8, wherein the at least one processor causes the IMS to further access at least one unstructured data from the plurality of unstructured data, and wherein to access the at least one unstructured data, the IMS:
receives a query vector;
searches the vector index stored on the relational database using the query vector to identify a nearest neighbour vector corresponding to the query vector; and
identifies the unstructured data using the nearest neighbour vector.

14. The IMS as claimed in claim 11, wherein the at least one processor causes the IMS to further insert a new vector in the vector database, and wherein to insert the new vector, the IMS is to:
retrieve the at least one entry point from the third table structure;
assign a new maximum layer to the new vector;
for each layer from the top layer to the new maximum layer, update an entry point corresponding to each layer by searching each layer with the new vector based on the at least one entry point
search for neighbour vectors for each layer from the new maximum layer to a last layer of the vector index, wherein the IMS is to:
search each layer with the new vector and the entry point corresponding to each layer to identify a plurality of nearest neighbour vectors corresponding to the new vector; and
identify a predetermined number of nearest neighbour vectors from amongst the plurality of nearest neighbour vectors corresponding to the new vector;
create an edge between the new vector and each vector from amongst the predetermined number of nearest vectors;
set the entry points to newly identified vectors;
update the entry point to be the new vector, if the new maximum layer is greater than the top layer; and
increment the top layer count.

15. The IMS as claimed in claim 14, wherein the IMS is to:
determine that the new maximum layer is greater than the top layer; and
set the new maximum layer to one level higher than top layer.

16. The IMS as claimed in claim 14, wherein the IMS is to:
determine that a list of neighbour vectors comprising the plurality of nearest neighbour vectors exceeds a maximum length (M); and
delete at least one existing edge.

17. A non-transitory computer-readable medium comprising instructions for implementation of a vector database, the instructions being executable by a processing resource to:
obtain a plurality of unstructured data;
perform vector embedding on each unstructured data from amongst the plurality of unstructured data to generate a plurality of vectors, wherein each vector from amongst the plurality of vectors is indicative of attributes of the unstructured data from amongst the plurality of unstructured data;
store the plurality of unstructured data and the plurality of vectors in the vector database;
generate a vector index corresponding to the plurality of vectors based on a first indexing mechanism, wherein the vector index comprises at least one cluster of vectors with similar attributes; and
perform an index mapping to store the vector index into a relational database.

18. The non-transitory computer-readable medium of claim 17, wherein
performing the index mapping comprises creating a first table structure comprising the plurality of vectors and metadata corresponding to the plurality of vectors; and
the metadata corresponding to each of the plurality of vectors comprises at least one of a vector ID, a tenant ID, an index name, and an identifier of a maximum layer at which each of the plurality of vectors is found.

19. The non-transitory computer-readable medium of claim 17, wherein
performing the index mapping comprises creating a second table structure comprising metadata corresponding to a first vector from amongst the plurality of vectors and a list of neighbour vectors corresponding to the first vector; and
the metadata corresponding to the first vector comprises at least one of a first vector ID, a first tenant ID, a first index name, and a first identifier of a layer comprising the first vector.

20. The non-transitory computer-readable medium of claim 19, wherein
performing the index mapping comprises creating a third table structure comprising an entry point for a query vector corresponding to the first vector and metadata corresponding to the first vector wherein the entry point corresponding to a top layer of the vector index; and
the metadata corresponding to the first vector comprises at least one of the first tenant ID, the first index name, and default and construction parameters corresponding to the first vector.

21. The non-transitory computer-readable medium of claim 17, wherein the medium further comprises accessing at least one unstructured data from the plurality of unstructured data, wherein the accessing comprises:
receiving a query vector;
searching the vector index stored on the relational database using the query vector to identify a nearest neighbour vector corresponding to the query vector; and
identifying the unstructured data using the nearest neighbour vector.

22. The non-transitory computer-readable medium of claim 20, wherein the medium further comprises deleting an existing vector from the vector database, wherein the deleting comprises:
identifying a plurality of neighbour vectors corresponding to the existing vector on each layer from the top layer to a last layer of the vector index; and
updating a list of neighbour vectors for each neighbour vector from amongst the plurality of neighbour vectors on each layer from the top layer to the last layer to remove reference to the existing vector.
